(19) United States
(12) Patent Application Publication
(10) Pub. No.: US 2004/0211162 A1
(43) Pub. Date: Oct. 28, 2004

(54) Portable air filtration tool (PAFT)

(76) Inventor: Leonard Marvin Henrikson, Roseburg, OR (US)

Correspondence Address: Tami Trowbridge, 215 N. Calapooia St., Sutherlin, OR, 97479, US

(21) Appl. No.: 10/423,109

(22) Filed: Apr. 25, 2003

(51) Int. Cl. B01D 46/00

(52) U.S. Cl. 55/385.2

(57) ABSTRACT

This invention treats the design of portable elements quickly assembled into one unit to filter air for a spectrum of contaminants from air supplied, extracted or circulated in an enclosed space.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

This invention describes a means for filtering air entering or being evacuated from a space or room when that air is toxic or contaminated.

It should be known that the hardware constituting this tool is already being copied, manufactured and sold in other countries, largely where hazard exists or is imminent.

Refer to existing U.S. Pat. No. 6,328,775B1, Fuchs. That patent provides the references cited by the examiners in their search.

### BRIEF SUMMARY OF THE INVENTION

The invention is an emergency ventilation system capable of being configured by the end user to supply filtered air into a room creating a positive pressure condition in the room or space, or to

draw and filter air from a room creating an isolation room or a negative pressure condition in the room or space.

A further useful application would be to simply put the unit in a room without wall penetrations and circulate the room air through the filter bank thus “laundering” the air.

The invention consists of three component elements: the intake hose kit, filtration unit, and quick-change blower module, all coupled together.

The invention is in kit form and can be installed in any space or room having a sliding horizontal or vertical window, patio door, HVAC return register, dryer vent, air tight containment or even penetrating an existing wall.

The invention is designed as a kit that can be configured and installed by anyone having basic assembly skills in less than 40 minutes time.

### BRIEF DESCRIPTION OF DRAWINGS

FIG. 1 shows the major elements: hose, filter pack and blower arranged for battery power, configured to penetrate a typical sliding window and providing a positive pressure to the space.

FIG. 2 shows the major elements powered from the power main, penetrating a typical, double-hung window for a negative pressure and so isolating that space, as would be the case if it were contaminated.

FIG. 3 shows the manually operated bellows, assuming all power is lost—penetrating a typical framed wall and drawing air into the room for positive pressure.

FIG. 4 shows how an interior room without exterior walls could tap into an HVAC register as an emergency air intake source.

FIG. 5 shows the filtration unit assembled as a typical NBC filtration system. The filter stack may use any number or combination of filters for specific filtering applications.

FIG. 6 shows the quick connection detail where the male and female tapers connect by simply stabbing together.

FIG. 7 shows a section through the manually operated bellows which could be used in event of both power and battery failure. It simply push-fits into the filter housing in lieu of the power blower.

The function of these drawings is to illustrate how readily the system can be put into service and how versatile the results. Not illustrated is the simple “laundering” of air within a space.

### DETAILED DESCRIPTION OF THE INVENTION

As will be obvious by now, the three separate elements: blower, filtration pack housing and hose can be fitted together and installed into room or space which converts the space into a safe room with positive air pressure, or alternately, feeding a closed room which creates a space with negative pressure for an isolation room. Which option is applied is dependent upon whether the filtered air is fed from or expelled to, the outside. Supplied together with these elements as a package, is a detailed instruction manual, with the emphasis on graphics for those unfamiliar with English. Rounding out the kit are the simple materials, which could be useful in making the connections through the shell of the rooms or space being protected.

A master key identifies the part numbers on the drawings. Subsidiary portions of those parts are assigned letters.

Items denoted with Arabic numerals are whole parts.

Items denoted with letters are part details.

| Number | Name |
|---|---|
| 1. | Vent, air intake or output |
| 2. | Reducer, vent-hose |
| 3. | Z-plate |
| 4. | Cover, window, pre-cut vinyl with adhesive strip |
| 5. | Hose |
| 6. | Filtration unit |
| 7. | Blower, D/C |
| 8. | Battery |
| 9. | Blower, A/C |
| 10. | Blower, hand bellows |
| 11. | Cover, HVAC register |
| 12. | J-bolt, |
| 13. | Collar, connection, hose |
| 14. | T-bar |
| 15. | Nut, wing |
| a. | Housing, intake |
| b. | Filter, gross |
| c. | Stops, travel |
| d. | Filter, pre |
| e. | Filter HEPA |
| f. | Shoulder, sealing, housing |
| g. | Seal, lower, HEPA |
| h. | Filter, adsorber, chemical, gas |
| i. | Seal, upper, HEPA |
| j. | Housing, output |
| k. | Seal, filter, upper, adsorber |
| l. | Spacers, tie-rod |
| m. | Holes, tie-rod |
| n. | Tie-rod, threaded |
| o. | Nut, hex, tie-rod |
| p. | Sleeve, connection, male, blower |
| q. | Receiver, connection, female, housing |
| r. | Coupling, hose, output |
| s. | Receiver, blower, bellows |
| t. | Sleeve, connection, male, housing |
| u. | Handle, operating, bellows |
| v. | Chamber, bellow |
| w. | Seat, valve, flapper, lower |
| x. | Valve, flapper, lower |
| y. | Valve, flapper, upper |
| z. | Seat, valve, flapper, upper |

### DETAILED DESCRIPTION OF THE INVENTION—continued

The invention consists of three component groups the intake hose kit, the filtration unit and the quick-change blower module. The blower provided operates on an electrical supply of 110 volt, 60 cycle or 230 volt (European), as well as providing a wiring jumper to 12 volt battery in event of power failure. A second backup exists in the manual blower (10).

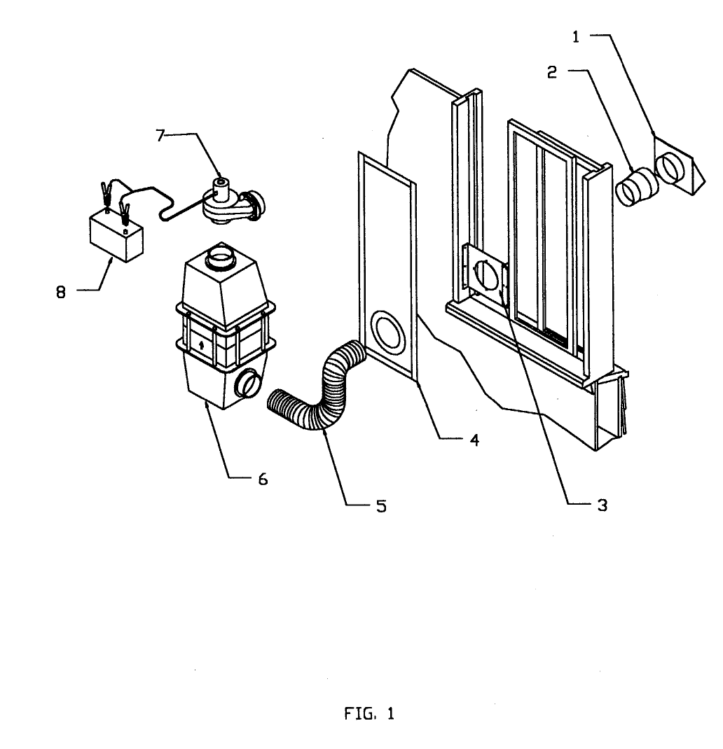

FIG. 1 of page 1/7, the invention is shown as a vertical sliding window connection configured as a positive pressure safe room system. Outside vent (1) is connected to reducer (2), connected to Z-plate (3) captured in window, covered by precut vinyl sheet (4) with pre-placed adhesive strips for attaching to window frame and Z-plate, hose (5) is connected to reducer (2) and filtration unit (6), air is drawn through system by blower (7), powered by battery (8), and blown into room. This configuration may also use blowers (9) or (10).

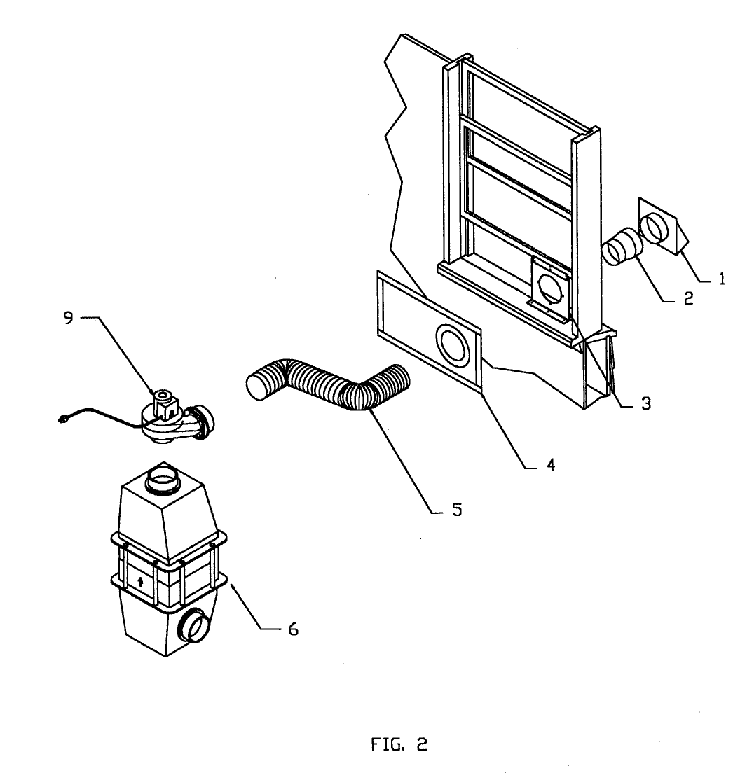

FIG. 2 page 2/7, the invention is shown as a horizontal sliding window connection configured as a negative pressure isolation room system. Connection parts (1) through (5) are assembled the same as in FIG. 1. The hose is connected to the output side of blower (7) or (9) drawing room air through the filter unit (6) and pushing air out of the room.

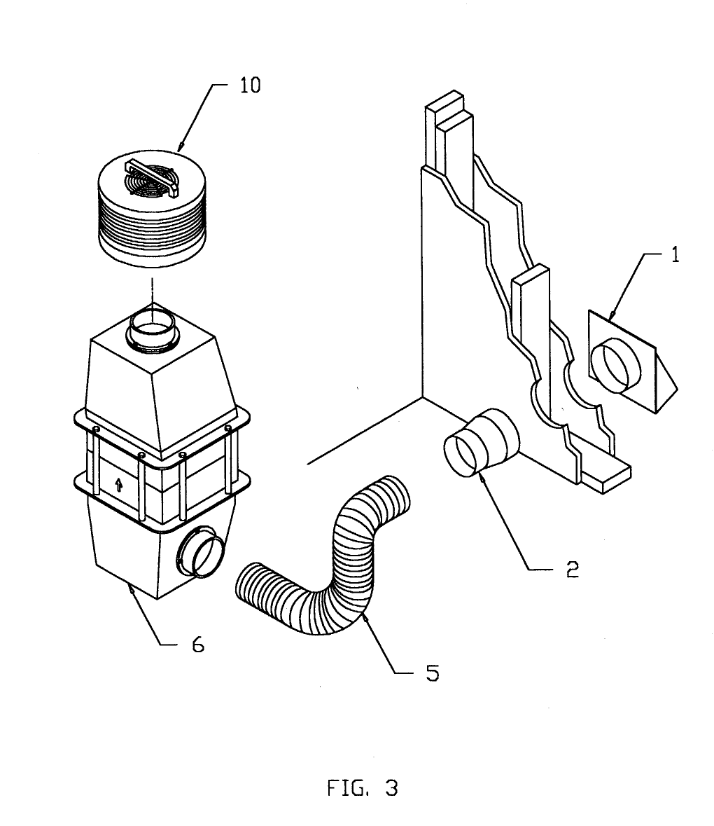

FIG. 3 of page 3/7, the invention is as a through-the-wall connection configured as an emergency filtered air intake for a safe room. Connection parts (1), (2) & (5) are assembled the same as in FIG. 1, the back-up hand bellows blower (10) is connected to the filtration unit (6) to pump air into the room.

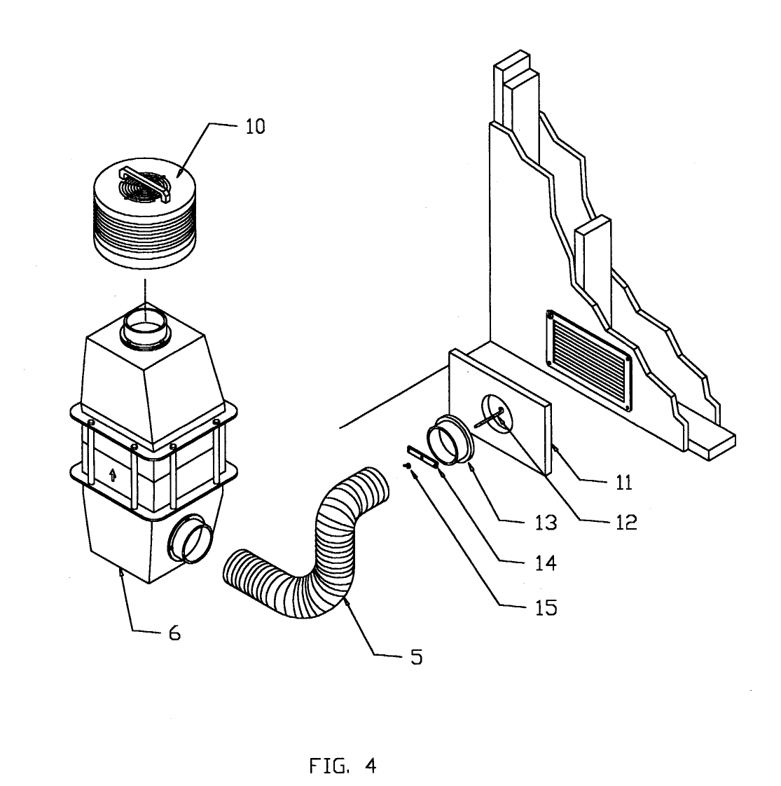

FIG. 4 of page 4/7, the invention is shown as an HVAC register connection in an emergency intake configuration. Connection parts hose collar (13) is seated into register cover (11), the cover assembly is placed and held over the register with one hand while with the other hand the J-bolt (12) is passed through the center of the collar (13) and hooked around a center grill fin of the register; T-bar (14) is slid over the threaded portion of the J-bolt and centered into position over the hose collar, wing nut (15) is threaded onto J-bolt drawing the assembly tightly fastened to the register, hose (5) is connected to the filtration unit (6).

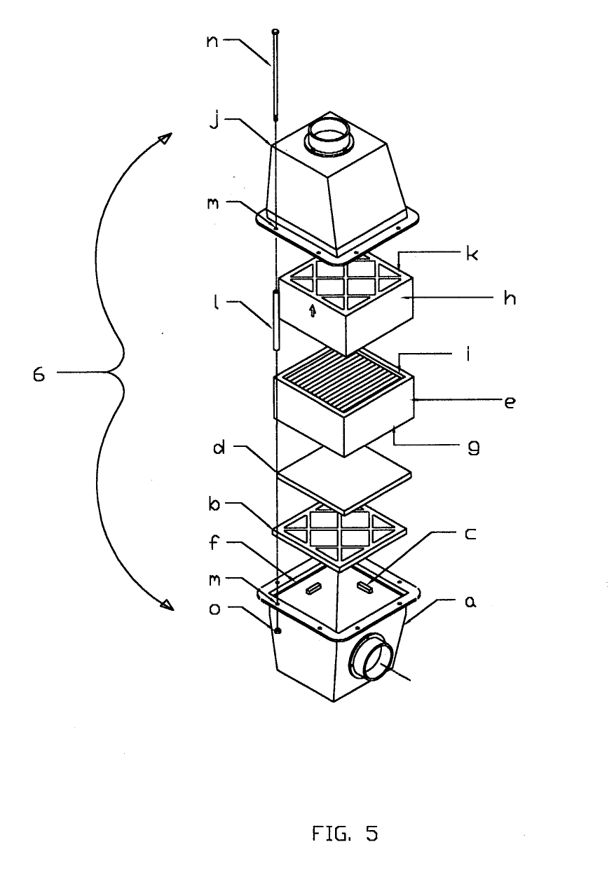

FIG. 5 of page 5/7, shows the configurable filtration unit (6) assembled as a typical NBC filtration system. This is only one of many possibilities; the filter stack may utilize any number or combination of filters as required for a particular filtering application. The lower intake housing (a) is placed on its end with the opening up. The gross filter (b) is placed in the opening and supported by the travel stops (c). The pre-filter (d) is placed on top of the gross filter. The HEPA particulate filter (e) is placed into the opening of the intake housing with its bottom rubber face seal (g) mating against the inner sealing shoulder (f) inside the intake housing (a). The gas adsorption filter (h) is placed on top of the HEPA particulate filter's upper face seal (i). The upper housing (j) is placed over the upper seal (k) of the gas adsorption filter (h). The tie-rod spacers (l) are aligned between the flange holes (m) of the upper and lower housing (j) & (a). The threaded tie-rod studs (n) are inserted through the upper and lower housing and spacer assemblies. Hex nuts (o) are secured clamping and sealing the filter assembly. The housing halves (j and a) can thus telescope as required in order to: renew filters or change filters to suit a particular application, which may have changed since purchase. All as desired by the end user.

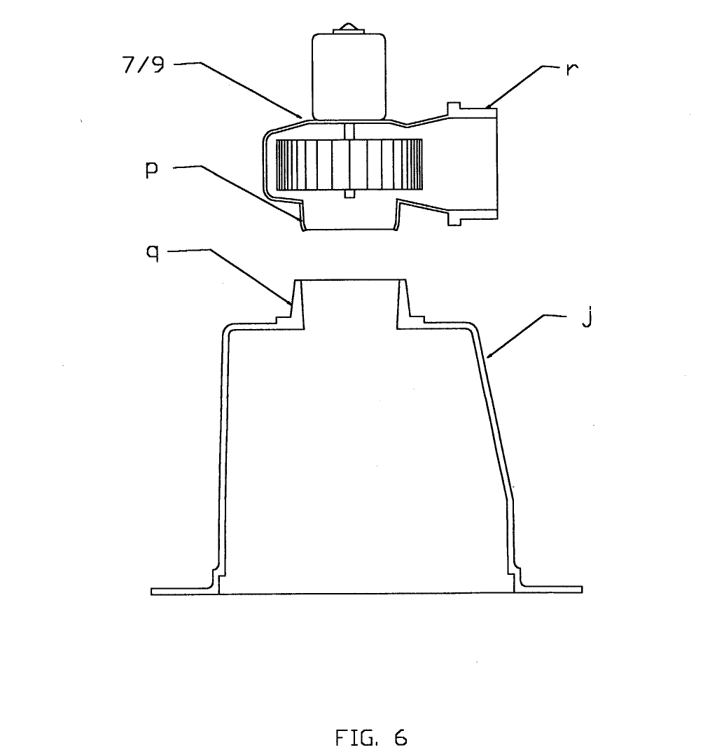

FIG. 6 of page 6/7 shows quick connection detail for the male tapered sleeve (p) of blowers (7) and (9) into female receiver (q) of output housing (j). Detail (r) is the hose coupling used for output when the system is configured as a negative pressure system as shown in FIG. 2 on page 2/7 of this document.

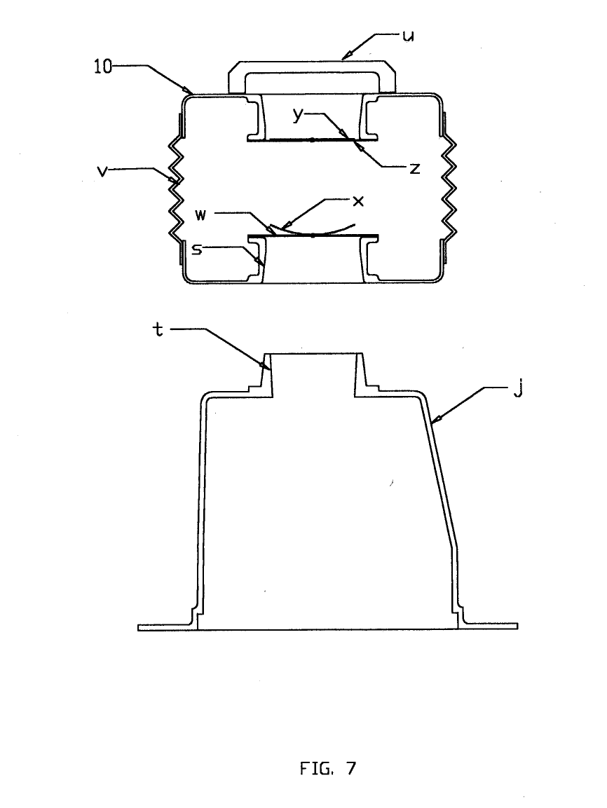

FIG. 7 of page 7/7 shows the quick connection detail for the female tapered receiver (s) of the vertical back-up hand operated blower (10) to the male sleeve (t) of the output housing (j). Retracting the bellows operating handle (u) draws a charge of air from the output housing through the filters into the bellows chamber (v), past valve seat (w) lifting flapper valve (x) while closing flapper valve (y) against valve seat (z). a down stroke reverses the said valve sequence and expels the air out the exhaust port underneath the operating handle.

What I claim as my invention is:

1. The design of the described portable elements for quick assembly into one functioning tool for the filtration of air of a spectrum of contaminants (sand, virus', gases, nuclear fallout) from air supplied to, extracted from or circulated within an enclosed space.

2. Given the state of the world, this Portable Air Filtration Tool could be a tool for survival.
